(19) United States
(12) Patent Application Publication
(10) Pub. No.: US 2026/0260307 A1
(43) Pub. Date: Sep. 3, 2026

(54) PLATFORM FOR WAGERING ON SPORTING EVENTS

(71) Applicant: GameDayMatch LLC, Boca Raton, FL (US)

(72) Inventor: William E. Hogwood, Boca Raton, FL (US)

(21) Appl. No.: 19/340,063

(22) Filed: Sep. 25, 2025

Related U.S. Application Data
(63) Continuation-in-part of application No. 18/524,214, filed on Nov. 30, 2023, now Pat. No. 12,430,700.
Application No. 18/524,214 is a continuation of application No. 17/230,486, filed on Apr. 14, 2021, now Pat. No. 11,875,423.
(60) Provisional application No. 63/009,760, filed on Apr. 14, 2020.
(60) Provisional application No. 63/842,592, filed on Jul. 11, 2025.

(51) Int. Cl. G06Q 50/34; G06F 17/11; G07F 17/32

(52) U.S. Cl. CPC G06Q 50/34; G06F 17/11; G07F 17/3244; G07F 17/3288

(57) ABSTRACT

A “CrossPlay” platform that provides functionality for users to form multi-selection sets by arranging predicted outcomes of sporting events in a 4×4 grid. Notably, in addition to the four user predictions in each row, column, and four-cell diagonal line, the CrossPlay platform also enables users to form winning combinations that require fewer than four correct predictions. Accordingly, the disclosed platform provides a sports-related game that is easy to understand and easy to play, even by casual sports fans.

### CROSS-REFERENCE TO RELATED APPLICATIONS

This application claims priority to U.S. Prov. Pat. Appl. No. 63/842,592, filed Jul. 11, 2025, and is a continuation-in-part of co-pending U.S. patent application Ser. No. 18/524,214, filed Nov. 30, 2023, which is a continuation of U.S. patent application Ser. No. 17/230,486, now U.S. Pat. No. 11,875,423, filed Apr. 14, 2021, which claims priority to U.S. Prov. Pat. Appl. No. 63/009,760, filed Apr. 14, 2020, which are all incorporated by reference.

### BACKGROUND

Many organizations that provide sports-related products (e.g., fantasy sports, daily fantasy, sports gaming, etc.) seek to broaden their market share by appealing to casual sports fans. The “GameDayMatch” platform described in U.S. Pat. No. 11,875,423 and U.S. patent application Ser. No. 18/524,214 improves the functioning of prior art sports gaming platforms by enabling users to construct a larger number of separate wagers (e.g., 15 separate wagers) than user selections (e.g., 4 user selections). However, to provide a platform that appeals to more casual sports fans, there is a need for further improvements to the functionality of prior art systems.

U.S. Pat. Pub. No. 2017/0193736 to Martino describes a system that enables users to arrange sports game outcome predictions in a 3×3 or larger grid. That system was limited, however, in that each winning combinations always required the same number of correct predictions (e.g., three correct predictions in a 3×3 grid). The lack of functionality to form winning combinations that include fewer correct predictions limits the appeal of the Martino system to casual sports fans.

### SUMMARY

In order to overcome those and other drawbacks of the prior art, the disclosed “CrossPlay” platform provides functionality for users to form multi-selection sets by arranging predicted outcomes of sporting events in a 4×4 grid. Notably, in addition to the four user predictions in each row, column, and four-cell diagonal line, the CrossPlay platform also enables users to form winning combinations that require fewer than four correct predictions. Accordingly, the disclosed platform provides a sports-related game that is easy to understand and easy to play, even by casual sports fans.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of an architecture of a system for wagering on sporting events according to an exemplary embodiment.

FIG. 2 is a block diagram of the system for wagering on sporting events according to an exemplary embodiment.

FIG. 3 is an explanation view output via the client user interface according to an exemplary embodiment.

FIG. 4 is a payout view output via the client user interface according to an exemplary embodiment.

FIG. 5 is a schedule view output via the client user interface according to an exemplary embodiment.

FIG. 6 is a user selection view output via the client user interface according to an exemplary embodiment.

FIG. 7 is a betslip view output via the client user interface according to an exemplary embodiment.

FIG. 8 is a results view output via the client user interface according to an exemplary embodiment.

FIGS. 9A and 9B are views of a “CrossPlay” client user interface according to an exemplary embodiment.

FIG. 10 illustrates an example 4×4 grid with four columns and four rows.

FIGS. 11A and 11B illustrate the diagonal lines that include multiple user selections in the example 4×4 grid of FIG. 10.

FIGS. 11C and 11D illustrate an example 4×4 grid that forms two four-selection diagonal sets that each include four user selections.

FIGS. 11E and 11F illustrate three-selection diagonal sets that each include only three user selections.

FIGS. 11G and 11H illustrate two-selection diagonal sets that each include only two user selections.

FIGS. 12A and 12B illustrate functionality to rearrange the user selections according to an exemplary embodiment.

FIGS. 13A and 13B illustrate each set of user selections in each column according to an exemplary embodiment.

FIGS. 14A and 14B illustrate each set of user selections in each row according to an exemplary embodiment.

FIGS. 15A and 15B illustrate each set of four user selections that form a diagonal line according to an exemplary embodiment.

FIGS. 16A and 16B illustrate each set of three user selections that form a diagonal line according to an exemplary embodiment.

FIGS. 17A and 17B illustrate each set of two user selections that form a diagonal line according to an exemplary embodiment.

FIGS. 18A and 18B illustrate functionality to make user selections relative to a point spread according to an exemplary embodiment.

FIGS. 19A and 19B illustrate functionality to make user selections relative to a point spread range according to an exemplary embodiment.

FIGS. 20A and 20B illustrate each set of four user selections that form a square in one of the four corners according to an exemplary embodiment.

FIGS. 20C through 20G illustrate each additional set of four user selections that form squares according to an exemplary embodiment.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

FIG. 1 is a diagram of an architecture 100 of a system for wagering on sporting events according to an exemplary embodiment.

As shown in FIG. 1, the architecture 100 includes a server 160 that communicates with client devices 120 via one or more networks 150. The server 160 may be in communication with computer readable storage media 180 via a wired connection, via one or more of the networks 150, etc. The server 160 may also be in communication with an operator interface 140 via a wired connection, via one or more of the networks 150, etc.

The server 160 may include any suitable computing device that executes instructions to perform the functions described herein. The server 160 may include, for example, a web server that provides a user interface that is accessible by the client devices 120 using a web browser. Additionally or alternatively, the server 160 may include an application server that makes software executed by the server 160 accessible to a software program executed by the client devices 120. The application server may be a mobile application server that makes software executed by the server 160 accessible to a mobile application running executed by the client devices 120.

The networks 150 may include local area networks 152, wide area networks 154 (e.g., the Internet), etc.

The computer readable storage media 180 may include any non-transitory hardware storage medium, such as a hard disk, solid-state memory, etc.

The client devices 120 may include any suitable computing device that executes instructions to send and receive data to/from the server 160 and provides a graphical user interface to receive instructions from a user and display information to that user. The remote computing devices 120 may include (desktop or notebook) personal computers 122, smartphones 124, and tablet computers 126. Similarly, the operator interface terminal 140 may be any suitable computing device that executes instructions to send and receive data to/from the server 160 and provides a graphical user interface to receive instructions from an operator and display information to that operator.

The client devices 120 may be co-located with the server 120 and/or the operator interface terminal 140, for example at a licensed sports wagering venue (commonly referred to as a “sportsbook”). In those instances, the client devices 120 may communicate with the server 120 and/or the operator interface terminal 140 via a local area network 152. In other embodiments, the client devices 120 may communicate with the server 120 and/or the operator interface terminal 140 via a wide area network 154, for example the Internet.

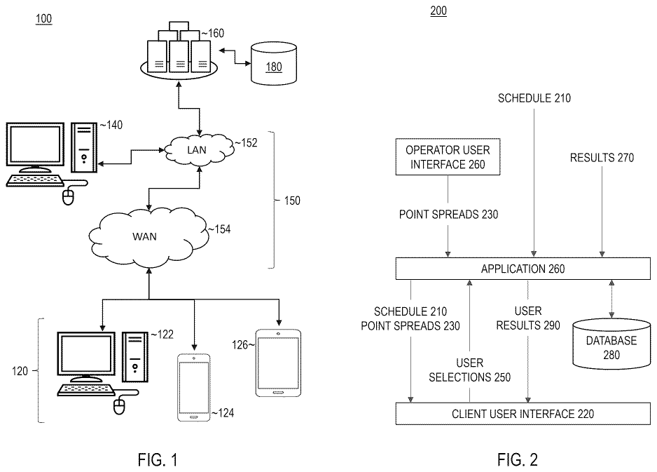

FIG. 2 is a block diagram of the system 200 for wagering on sporting events according to an exemplary embodiment.

As shown in FIG. 2, the system 200 includes a software application 260, which may be executed by the server 160, and a database 280, which may be stored on the computer readable storage media 180. The system 200 also includes an operator user interface 260 that provides functionality for an operator to view the schedule 210 of sporting events an input a point spread 230 for each sporting event. The operator user interface 260 may be provided to the operator interface terminal 140. The system 200 also includes a client user interface 220 that provides functionality for users to view the schedule 210 of sporting events (and, in some implementations, the point spread 230 for each sporting event) and input user selections 250. The operator user interface 260 may be provided to the client devices 120.

As described above, the software application 260 receives a schedule 210 of sporting events (e.g., from a third party via the one or more networks 150). The software application 260 then provides functionality for an operator to set point spreads 230 for those sporting events using the operator user interface 260. The schedule 210 and the points spreads 230 are output to users via the client user interface 220, which provides functionality for user to make selections 250 predicting the outcomes of the sporting events. The software application 260 also receives the results 270 of the sporting events (e.g., from the same third party that provided the schedule 210). Comparing the results 270 of the sporting events to the user selections 250, the software application 260 can determine and output user results 290 indicating whether the user has correctly predicted the outcomes of the sporting events. The schedule 210, the point spreads 230, the user selections 250, the results 270, and the user results 290 may be stored in the database 280.

### “GameDayMatch” Platform

As described in the GameDayMatch patents, the system 200 includes two novel features that can be employed separately or in combination. The first feature is that point spreads may be listed as whole integers, creating the possibility that the outcome of the sporting event will match the point spread exactly and neither team will win the sporting event after adjusting for the point spread. The point spread may even be listed as a small range (e.g., a 2- to 3-point range). Participants are therefore given the option to select that the outcome of the sporting event will match the point spread exactly (sometimes referred to as a “push”).

Because the point spread rarely matches the outcome of a sporting event exactly, the odds of winning any wager that the outcome will match the point spread are lower, but the payoff for being correct is much higher than the payoff for correctly selecting that one of the teams will cover the point spread. Similar to slot machines, the system 200 allows participants to make a series of relatively small wagers. Also similar to slot machines, a small possibility exists for a large payout.

The second feature is that, by selecting the outcome of a number of sporting events, the participant is in effect wagering on the outcome of each selected sporting event individually and each combination of the selected sporting events. Mathematically, for n selections, the system 200 enables the user to make

$${\sum }_{k = 1}^{n} ( \begin{matrix}n \\ k\end{matrix} )$$

separate wagers, where

$$( \begin{matrix}n \\ k\end{matrix} )$$

is the binomial coefficient. In other words, when a user makes n selections, the system 200 enables the user to make a separate wager on each selection, each group of two selections, etc., concluding with a single group of n selections.

To use an example, a participant may make the following three selections: the New York Knicks (+1 or +2) over the Charlotte Hornets, the Philadelphia 76ers (−11 or −12) over the Golden State Warriors, and the New Orleans Pelicans (−7 or −8) over the Cleveland Cavaliers. In that example, the participant is making seven separate wagers:
Single-game wager (1 Single): the New York Knicks (+1 or +2) over the Charlotte Hornets
Single-game wager (1 Single): the Philadelphia 76ers (−11 or −12) over the Golden State Warriors
Single-game wager (1 Single): the New Orleans Pelicans (−7 or −8) over the Cleveland Cavaliers
Two-game parlay (1 Double): the New York Knicks (+1 or +2) over the Charlotte Hornets and the Philadelphia 76ers (−11 or −12) over the Golden State Warriors
Two-game parlay (1 Double): the New York Knicks (+1 or +2) over the Charlotte Hornets and the New Orleans Pelicans (−7 or −8) over the Cleveland Cavaliers
Two-game parlay (1 Double): the Philadelphia 76ers (−11 or −12) over the Golden State Warriors and the New Orleans Pelicans (−7 or −8) over the Cleveland Cavaliers
Three-game parlay (1 Treble): the New York Knicks (+1 or +2) over the Charlotte Hornets, the Philadelphia 76ers (−11 or −12) over the Golden State Warriors, and the New Orleans Pelicans (−7 or −8) over the Cleveland Cavaliers

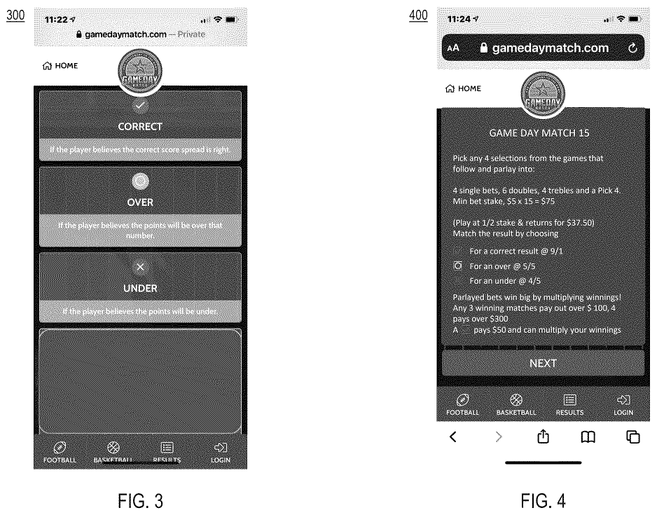

FIG. 3 is an explanation view 300 output via the client user interface 220 according to an exemplary embodiment.

As shown in the view 300, a user selection 250 that the favorite will win the sporting event by more than the point spread 230 is referred to as an “over” in this embodiment. By contrast, a user selection 250 that the favorite will not win the sporting event by an amount equal to or greater than the point spread 230 is referred to as an “under.” Additionally, a user may make a user selection 250 that the point spread 230 is “correct” and the result of the sporting event will be at (or within the range of) the point spread 230.

FIG. 4 is a payout view 400 output via the client user interface 220 according to an exemplary embodiment.

As shown in the payout view 400, making four user selections 250 is, in effect, making fifteen separate wagers: each single game individually, six separate two-game parlays (referred to as “doubles” in this embodiment), four three-game parlays (referred to as “trebles” in this embodiment), and a four-game parley (referred to as a “pick 4” in this embodiment).

As also shown in the payout view 400, a participant's winnings may differ for different user selections 250. In the embodiment shown, each “over” pays $5 for each $5 wagered, each “under” pays $4 for each $5 wagered, and each selection that the point spread 230 is “correct” pays $45 for each $5 wagered. In each instance, the wager is also returned to the user if the user selection 250 is correct. For parlays, a participant's winnings may be calculated by multiplying the odds for each correct user selection 250. For example, a two-game parlay where the user selections are “over” (5/5) and “correct” (45/5) may pay $90 for each $5 wagered.

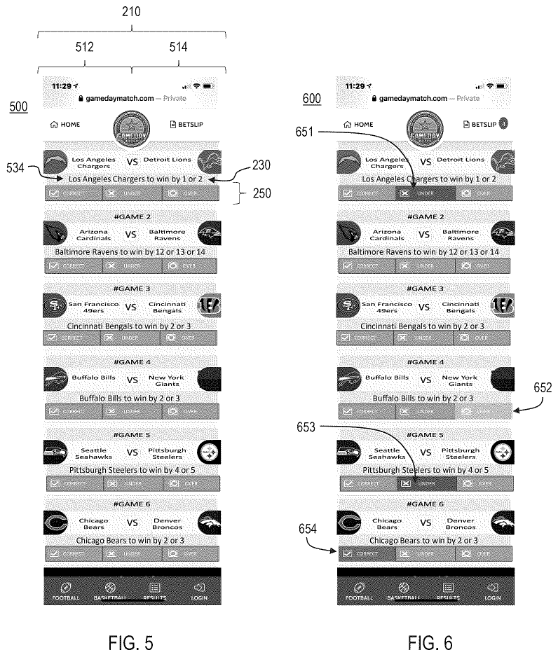

FIG. 5 is a schedule view 500 output via the client user interface 220 according to an exemplary embodiment.

As shown in FIG. 5, the schedule view 500 includes a schedule 210 of sporting events, each sporting event including a home team 512 and a visiting team 514. The schedule view 500 also includes a point spread 230 for each sporting event, selected by an operator using the operate user interface 260, which includes the team that is favored to win the game (i.e., the favorite 534) and number of points (or, in this embodiment, a range of points) by which the favorite 534 is expected to win the game. The view 500 provides functionality for a user to input a user selection 250 for each sporting event. As described above, a user selection may be an indication that the favorite 534 will win by more than the point spread 230 (“over”), that the favorite 534 will not win by an amount equal to or greater than the point spread 230 (“under”), or that the favorite 534 will win by the amount of the point spread 230 (“correct”).

FIG. 6 is a user selection view 600 output via the client user interface 220 according to an exemplary embodiment.

As shown in FIG. 6, the example user selection view 600 includes four user selections 651 through 654.

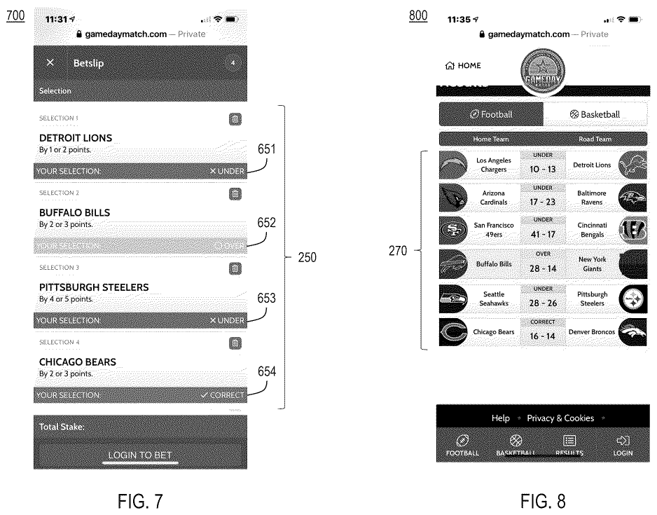

FIG. 7 is a betslip view 700 output via the client user interface 220 according to an exemplary embodiment.

As shown in FIG. 7, the betslip view 700 includes each of the user selections 250, including the user selections 651 through 654. The betslip view 700 illustrates one of the key benefits of the system 200. As explained above, the user is actually making fifteen separate wagers. However, the user only needs to make four user selections 250 and follow the results 270 of four sporting events. Meanwhile, a small possibility exists for a large payout exists, for example if all four user selections 250 are correct. The potential payout is especially large, in this example, because the user selection 654 is that the point spread 230, which is only a 2-point range, is correct.

FIG. 8 is a results view 800 output via the client user interface 220 according to an exemplary embodiment.

As shown in FIG. 8, the results view 800 includes the results 270 of the sporting events included in the schedule 210. The results view 800 may also include the user selections 250 and whether those user selections 250 were correct.

In addition to the fixed payouts described above, there are a number of different ways in which a participant's winnings may be calculated. In one embodiment, the wagers made by a user who predicts the outcome of a certain sporting event may be placed into a pool with all of the wagers made by users who predicted the outcome of that sporting event. By the same token, every potential parley bet during a certain time period may be pooled. For example, users making a two-team parlay regarding two specific sporting events may have that wager pooled and the users who make the accurate user selection 250 regarding both of those sporting events may win the pool.

In another embodiment, all of the wagers from all of the participants may be placed in a single pool. Regardless of whether the wagers using the system 200 are combined into a single pool or whether separate pools are made for each sporting event or combination of sporting events, a percentage of the total amount wagered may be retained by the operator before the remainder is distributed to the winners.

### “CrossPlay” Platform

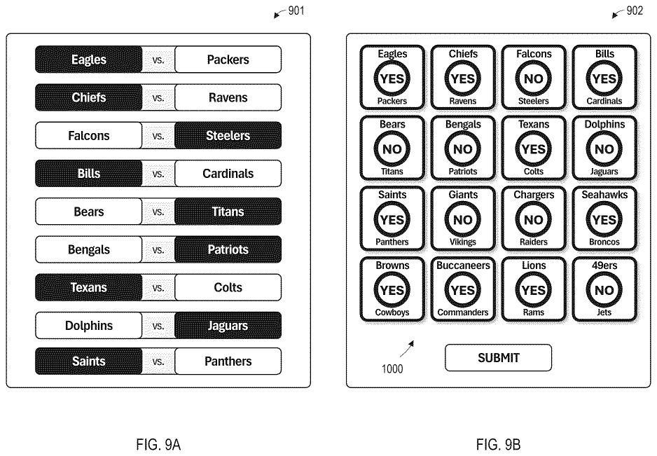

In the embodiments described below with reference to in FIGS. 9A through 20G (referred to herein as “the CrossPlay platform”), the system 200 provides functionality for users to form multi-selection sets by arranging the user selections 250 in a grid. Notably, in addition to the four-selection sets formed in each row, column, and four-cell diagonal line, the CrossPlay platform also generates additional multi-selection sets, for example that include only three user selections 250 or two user selections 250.

FIGS. 9A and 9B illustrate views 901 and 902 of the client user interface 220 according to an exemplary embodiment.

As described above, the software application 260 receives a schedule 210 of sporting events (e.g., from a third party via the one or more networks 150). The sporting events on the schedule 210 are output to users via the client user interface 220, which provides functionality (for example, as shown in FIG. 9A) for the user to make selections 250 predicting the results 270 of the sporting events. In the embodiment of FIGS. 9A and 9B, the system provides functionality for users to make sixteen user selections 250, which are arranged in a grid 1000 (in this example, a 4×4 grid 1000).

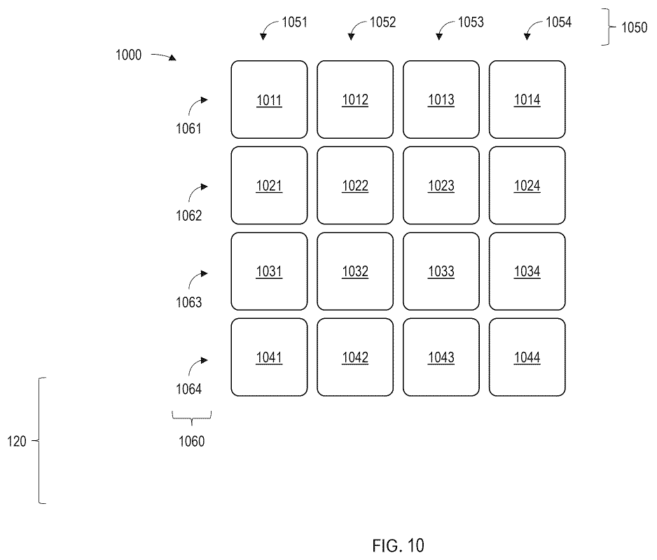

FIG. 10 illustrates the illustrates the rows 1050 and columns 1060 formed by the example 4×4 grid 1000.

As shown in FIG. 10, the example 4×4 grid 1000 includes sixteen cells 1011-1014, 1021-1024, 1031-1034, and 1041-1044 arranged in four columns 1051-1054 (generically and collectively referred to as columns 1050) and four rows 1061-1064 (generically and collectively referred to as rows 1060).

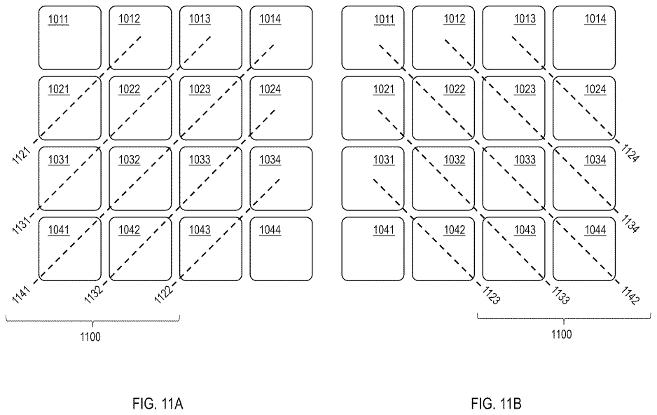

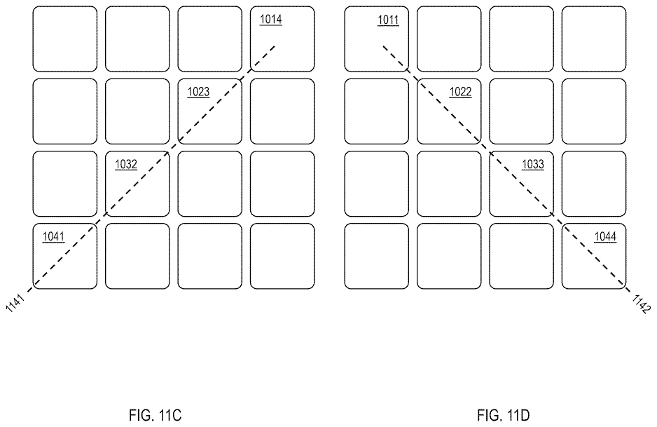

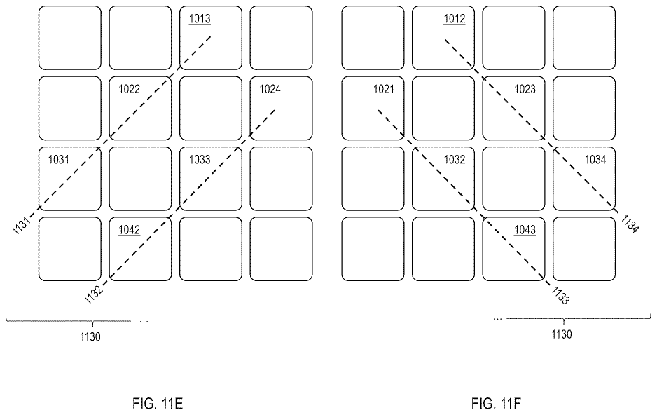

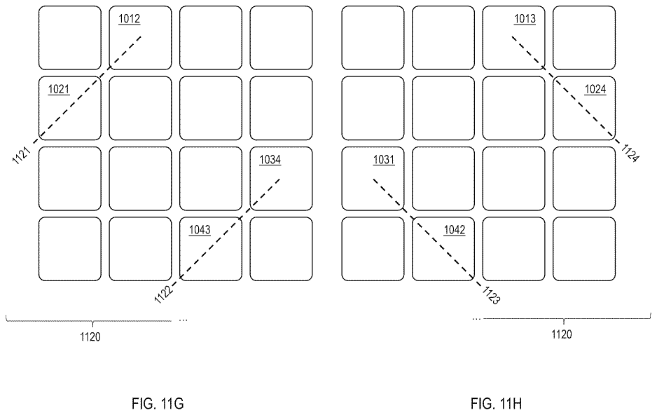

FIGS. 11A-11H illustrate the multi-selection diagonal sets 1100 formed by the system 200 according to an exemplary embodiment.

In the embodiments of FIGS. 11A-11H, each set of multiple cells (i.e., each set of multiple user selections 250) that are offset in the grid 1000 at an angle of 45 degrees forms a diagonal set 1100. As shown in FIGS. 11C-11D, for instance, the example 4×4 grid 1000 forms two four-selection diagonal sets 1041 and 1042 that each include four user selections 250.

Notably, as shown in FIGS. 11E-11F, the CrossPlay platform also forms three-selection diagonal sets 1130 that each include only three user selections 250. In the embodiment of FIGS. 11E-11F, for example, the three-selection diagonal sets 1130 include three-selection diagonal set 1131 (including the user selections 250 in cells 1031, 1022, and 1013), three-selection diagonal set 1132 (including the user selections 250 in cells 1042, 1033, and 1024), three-selection diagonal set 1133 (including the user selections 250 in cells 1021, 1032, and 1043), and three-selection diagonal set 1134 (including the user selections 250 in cells 1012, 1023, and 1034).

Additionally, as shown in FIGS. 11G-11H, the CrossPlay platform also forms two-selection diagonal sets 1120 that each include only two user selections 250. In the embodiment of FIGS. 11G-11H, for example, the two-selection diagonal sets 1120 include two-selection diagonal set 1121 (including the user selections 250 in cells 1021 and 1012), two-selection diagonal set 1122 (including the user selections 250 in cells 1043 and 1034), two-selection diagonal set 1123 (including the user selections 250 in cells 1031 and 1042), and two-selection diagonal set 1124 (including the user selections 250 in cells 1013 and 1024).

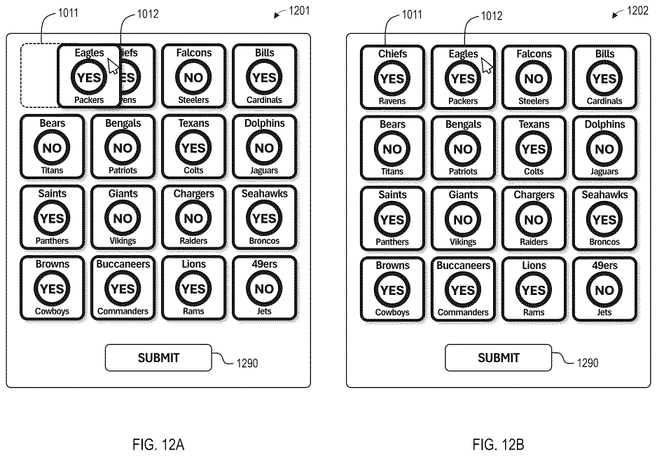

FIGS. 12A-12B illustrate views 1201 and 1202 of the client user interface 220 according to an exemplary embodiment.

As shown in FIGS. 12A-12B, the client user interface 220 provides functionality (e.g., via a touchscreen, a mouse, etc.) to rearrange each user selection 250 in the grid 1000 before submitting those user selections 250 (e.g., via a submit button 1290) as arranged in the grid 1000 by the user. In the example of FIGS. 12A-12B, for instance, the user may move the user selection 250 in cell 1011 (in this instance, the Philadelphia Eagles over the Green Bay Packers) to cell 1012, causing the user selection 250 previously in cell 1012 (in this instance, the Kansas City Chiefs over the Baltimore Ravens) to move into vacated cell 1011.

As described above, the software application 260 also receives the results 270 of the sporting events (e.g., from the same third party that provided the schedule 210). Comparing the results 270 of the sporting events to the user selections 250, the software application 260 can determine and output user results 290 indicating whether the user has correctly predicted the results 270 of the sporting events.

The goal of the user of the CrossPlay platform is to form as many winning combinations as possible. In the embodiments described above, a winning combination is one in which each of the results 270 are correctly predicted in all of the user selections 230 arranged in a column 1050, in a row 1060, or in a diagonal set 1100.

FIG. 12C illustrates a view 1203 of the client user interface 220 according to an exemplary embodiment.

In the embodiment of FIG. 12C, the client user interface 220 shows the correct 1240 user selections 250 (in the form of an “O”) and the incorrect 1260 user selections 250 (in the form of an “X”). The client user interface 220 also indicates the number of multi-selection sets where each of the user selections 250 are correct (“winning lines” 1280).

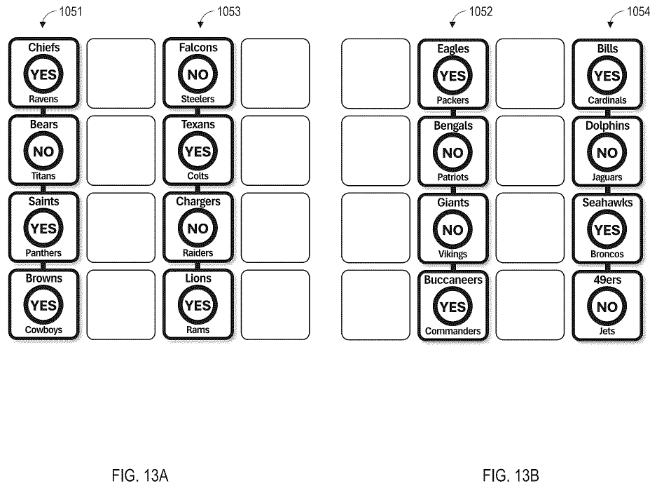

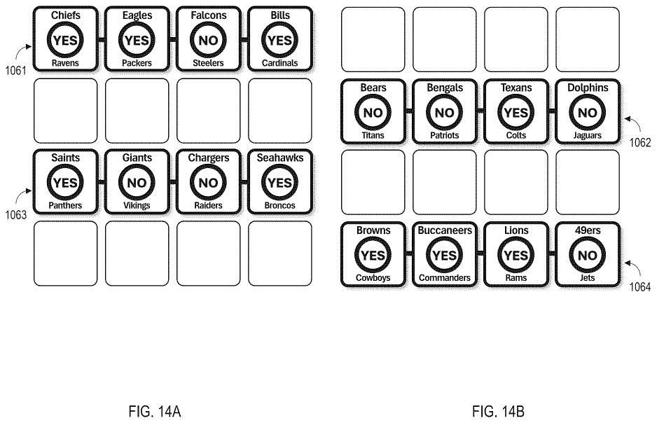

FIGS. 13A and 13B illustrate example winning combinations along each column 1060 of the grid 1000.

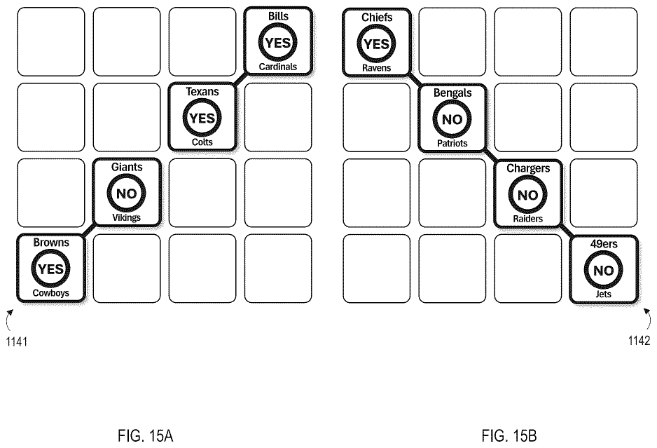

FIGS. 14A and 14B illustrate example winning combinations along each row 1050 of the grid 1000.

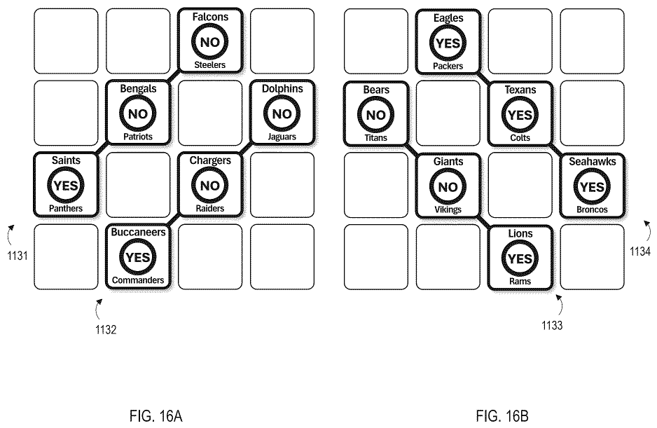

FIGS. 15A and 15B illustrate example winning combinations along each four-selection diagonal set 1040 formed by the grid 1000.

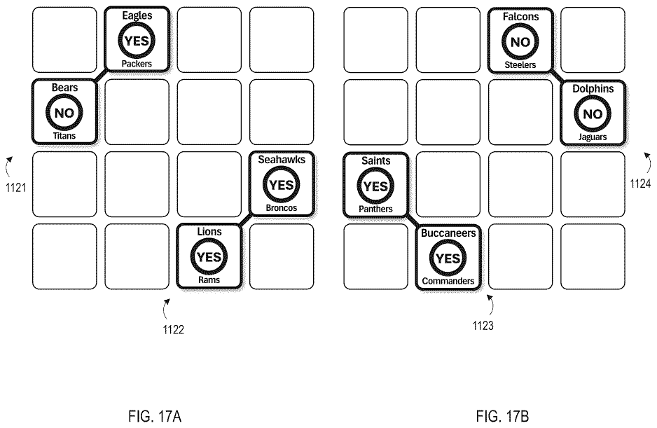

FIGS. 16A and 16B illustrate example winning combinations along each three-selection diagonal set 1030 formed by the grid 1000.

FIGS. 17A and 17B illustrate example winning combinations along each two-selection diagonal set 1020 formed by the grid.

The CrossPlay platform may be operated as a game in which users compete to earn the highest number points that are awarded for each winning combination. Additionally or alternatively, the CrossPlay platform may be operated by a licensed gaming provider that accepts wagers and awards payouts for each winning combination. Because the probability of forming a winning combination decreases as the required number of correct user selections 250 increases, users may receive more points (or higher payouts) for forming winning combinations that require more correct user selections 250.

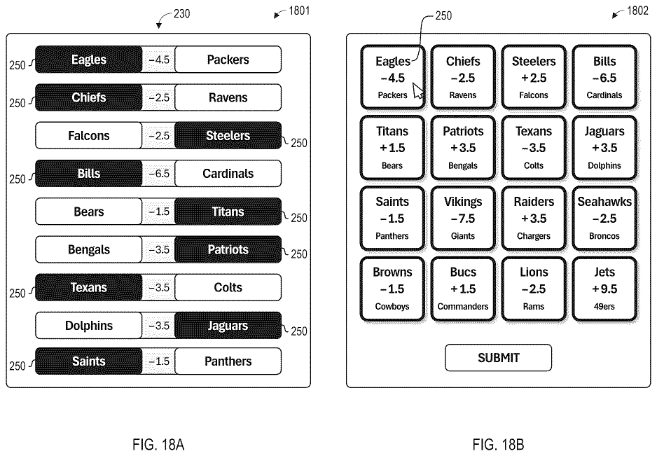

FIGS. 18A and 18B illustrate views 1801 and 1802 of the client user interface 220 according to another exemplary embodiment.

In the embodiments described above, the CrossPlay platform provides functionality for users to make user selections 250 predicting which team will win each sporting event on the schedule 210. In other embodiments, the software application 260 may provide functionality for users to make user selections 250 predicting the result 270 of each sporting event relative to a point spread 230 (for example, as shown in FIG. 18A) and arrange those user selections 250 in the grid 1000 (as shown in FIG. 18B). In those embodiments, the software application 260 may receive the point spreads 230 for the sporting events on the schedule 210 from a third party (e.g., from the same third party that provides the schedule 210). Additionally or alternatively, the software application 260 may provide functionality for an operator to set and/or adjust the point spreads 230 using the operator user interface 260.

In the embodiment of FIGS. 18A and 18B, the CrossPlay platform provides functionality for users to make user selections 250 predicting that either the team that is favored to win (“the favorite”) will win the game by more than the point spread 250 or the team that is not favored (“the underdog”) will win the game outright or keep the score differential from exceeding the point spread 250. In those embodiments, the point spreads 250 typically include a half-point (e.g., as shown in 18A and 18B), meaning that either the favorite or the underdog will win the game relative to the point spread 250. Otherwise, if the point spread 250 is an integer, the result 270 of the sporting event may match the point spread 250 exactly (often called a “push”).

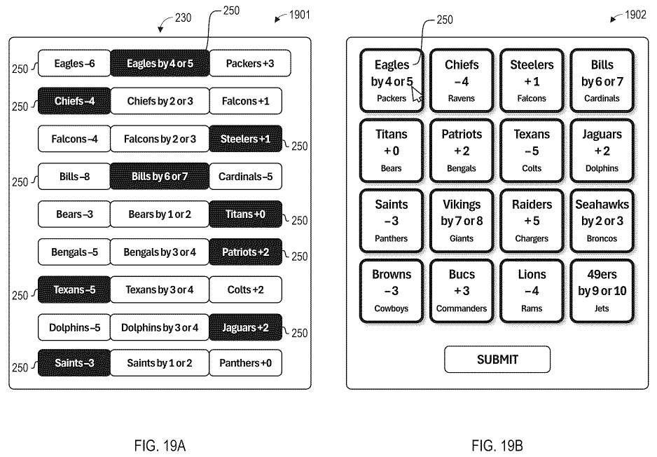

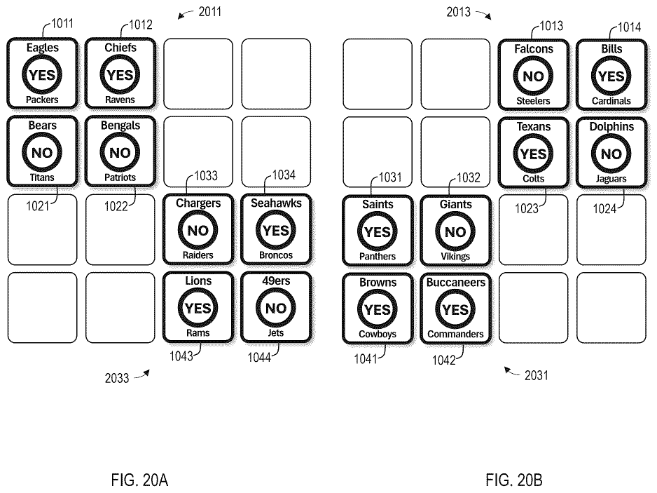

FIGS. 19A and 19B illustrate views 1901 and 1902 of the client user interface 220 according to another exemplary embodiment.

In the embodiment of FIGS. 18A and 18B described above, each point spread 250 includes a half point to prevent situations in which the 270 of the sporting event may match the point spread 250 exactly. In other embodiments, the point spreads 250 may be an integer or a range of integers (e.g., as shown in FIG. 19A). In those embodiments, CrossPlay platform may provide functionality for users to make user selections 250 (e.g., as shown in FIG. 19A) predicting that the favorite will win the sporting event by more than the point spread 250, that the favorite will win the sporting event by an amount that is equal to (or within the range of) the point spread 250, or that the underdog will win the sporting event outright or lose by a score differential that is less than the point spread 250. Because a favorite winning a sporting event by an amount that is equal to an integer (or even within a narrow range of integers) is less likely than the result 270 of the sporting event being more or less than the point spread 230, users may earn more points (or a greater return on their wager) for correctly predicting that the result 270 of a sporting event will be equal to a point spread 230 integer or within a point spread 230 range.

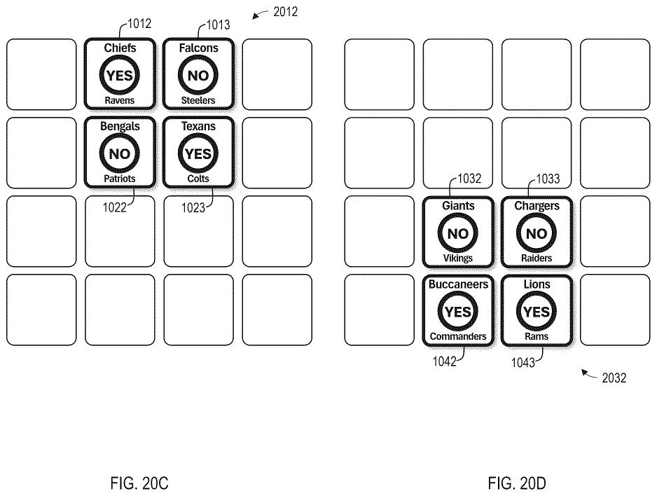

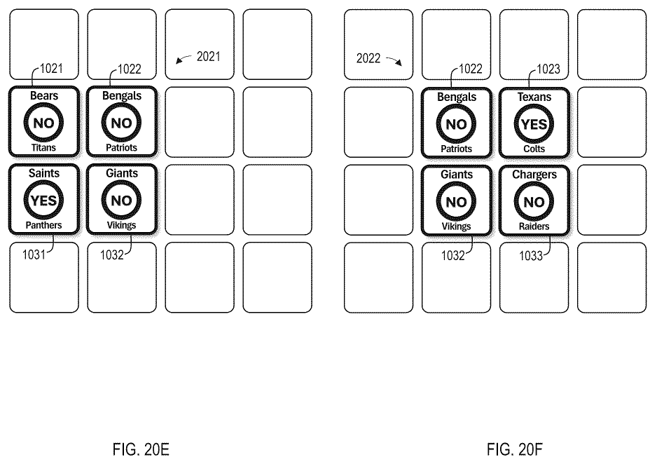

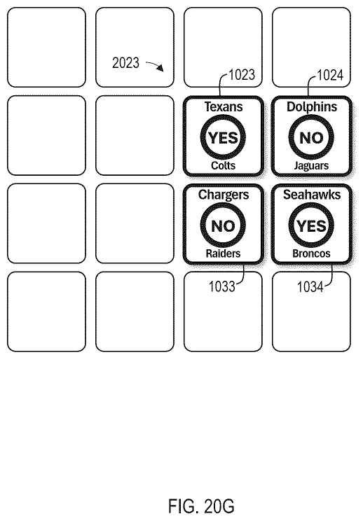

FIGS. 20A-20G illustrate additional sets of grid cells that may form winning combinations in some embodiments of the disclosed system 200.

As shown in FIGS. 20A and 20B, for example, in some implementations the CrossPlay platform may be configured such that four correct user selections 250 forming a 2×2 square in any of the four corners of the grid 1000 is also considered a winning combination. As shown in FIGS. 20A and 20B, for instance, the winning combinations may include a top-left square set 2011 (that includes the user selections 250 in cells 1011, 1012, 1021, and 1022), a top-right square set 2013 (that includes the user selections 250 in cells 1013, 1014, 1023, and 1024), a bottom-left square set 2033 (that includes the user selections 250 in cells 1033, 1034, 1043, and 1044), and a bottom-right square set 2031 (that includes the user selections 250 in cells 1031, 1032, 1041, and 1042).

In other implementations, the CrossPlay platform may be configured such that four correct user selections 250 forming any 2×2 square is considered a winning combination. As shown in FIGS. 20C-20G, for instance, the winning combinations may include a top square set 2012 (that includes the user selections 250 in cells 1012, 1013, 1022, and 1023) as shown in FIG. 20C, a bottom square set 2032 (that includes the user selections 250 in cells 1032, 1033, 1042, and 1043) as shown in FIG. 20D, a left square set 2021 (that includes the user selections 250 in cells 1021, 1022, 1031, and 1032) as shown in FIG. 20F, a center square set 2022 (that includes the user selections 250 in cells 1022, 1023, 1032, and 1033) as shown in FIG. 20F, and a right square set 2023 (that includes the user selections 250 in cells 1023, 1024, 1033, and 1034) as shown in FIG. 20G.

In some embodiments, the CrossPlay platform may be configured such that winning combinations may also be formed by six correct user selections 250 forming a 2×3 or 3×2 rectangle, eight correct user selections 250 forming a 2×4 or 4×2 rectangle, nine correct user selections 250 forming a 3×3 square, twelve correct user selections 250 forming a 3×4 or 4×3 rectangle, and/or sixteen correct user selections 250 in each of the sixteen grid cells. Because the probability of forming a winning combination decreases as the number of user selections 250 increases, users may receive more points (or higher payouts) for forming winning combinations that require more correct user selections 250. In some implementations, the CrossPlay platform may also award points (or payouts) for each individual correct user selection 250.

While the system 200 is described above as providing functionality for users to predict the winner of each sporting event (in some implementations, relative to a point spread 230), the system 200 may also be configured to provide functionality for users to predict other results 270 relative to a number (typically referred to as an “over-under”) or range of integers received or specified by the operator. For instance, the system 200 may provide functionality for users to predict the total points scored in a sporting event, the total points scored (or any other statistical metric) accrued by an individual player, etc. In those embodiments, unique combinations of each of the user predictions 230 may be used to form multiple separate sets or wagers (e.g., by the GameDayMatch platform described above), for example by providing functionality (described above with reference to the CrossPlay platform) for the user to arrange those user predictions 230 in a grid 1000.

While preferred embodiments have been set forth above, those skilled in the art who have reviewed the present disclosure will readily appreciate that other embodiments can be realized within the scope of the invention. For example, the system 200 is described with reference to certain sporting events. However, the system 200 may provide a platform for wagering on any sporting event.

What is claimed is:

1. A platform for predicting the outcome of sporting events, the platform comprising:
non-transitory computer readable media that stores a schedule of sporting events;
a graphical user interface that provides functionality for users to:
make 16 user selections predicting the outcome of 16 sporting events; and
form at least 18 separate multi-selection sets by arranging the 16 user selections in a 4×4 grid having sixteen cells arranged in four rows and four columns, the at least 18 separate multi-selection sets comprising:
4 four-selection sets along each row of the 4×4 grid;
4 four-selection sets along each column of the 4×4 grid;
2 four-selection sets along each four-cell diagonal line of the 4×4 grid;
4 three-selection sets along each three-cell diagonal line of the 4×4 grid; and
4 two-selection sets along each two-cell diagonal line of the 4×4 grid; and
a server that receives data indicative of the outcome of each of the 16 sporting events and determines whether each of the multi-selection sets formed by the user are a winning combination in which all of the user selections correctly predicted the outcome of each sporting event.

2. The platform of claim 1, wherein 4×4 grid provides functionality to form an additional 4 four-selection sets, the additional 4 four-selection sets comprising each 2×2 set of four cells in two rows and two columns in each corner of the 4×4 grid.

3. The platform of claim 1, wherein 4×4 grid provides functionality to form an additional four-selection set in each 2×2 set of four cells in two rows and two columns.

4. The platform of claim 1, wherein the user selections predict the outcome of each sporting event relative to a point spread.

5. The system of claim 4, wherein the server provides an operator user interface that provides functionality for an operator to set the point spread for each of the sporting events.

6. The system of claim 4, wherein the point spreads are received by the server via the internet.

7. The system of claim 4, wherein the point spreads are integers.

8. The system of claim 7, wherein the functionality for users to make each user selection predicting the outcome of each sporting event comprises functionality for the user to predict that a team favored to win will win by the amount of the point spread.

9. The system of claim 4, wherein the point spreads are a range greater than 1.

10. The system of claim 9, wherein the functionality for users to make each user selection predicting the outcome of each sporting event comprises functionality for the user to predict that a team favored to win will win by an amount within the range of the point spread.

11. A method of providing a platform for wagering on sporting events, the method comprising:
receiving a schedule of sporting events;
providing functionality for users to make 16 user selections predicting the outcome of 16 sporting events; and
providing functionality to form at least 18 separate multi-selection sets by arranging the 16 user selections in a 4×4 grid having sixteen cells arranged in four rows and four columns, the at least 18 separate multi-selection sets comprising:
4 four-selection sets along each row of the 4×4 grid;
4 four-selection sets along each column of the 4×4 grid;
2 four-selection sets along each four-cell diagonal line of the 4×4 grid;
4 three-selection sets along each three-cell diagonal line of the 4×4 grid; and
4 two-selection sets along each two-cell diagonal line of the 4×4 grid.

12. The method of claim 11, wherein 4×4 grid provides functionality to form an additional 4 four-selection sets, the additional 4 four-selection sets comprising each 2×2 set of four cells in two rows and two columns in each corner of the 4×4 grid.

13. The method of claim 11, wherein 4×4 grid provides functionality to form an additional four-selection set in each 2×2 set of four cells in two rows and two columns.

14. The method of claim 11, wherein the user selections predict the outcome of each sporting event relative to a point spread.

15. The method of claim 14, further comprising:
providing an operator user interface that provides functionality for an operator to set the point spread for each of the sporting events.

16. The method of claim 14, further comprising:
receiving the point spread for each of the sporting events via the internet.

17. The method of claim 14, wherein the point spreads are integers.

18. The method of claim 7, wherein the functionality for users to make each user selection predicting the outcome of each sporting event comprises functionality for the user to predict that a team favored to win will win by the amount of the point spread.

19. The method of claim 14, wherein the point spreads are a range greater than 1.

20. The method of claim 19, wherein the functionality for users to make each user selection predicting the outcome of each sporting event comprises functionality for the user to predict that a team favored to win will win by an amount within the range of the point spread.
